(19) United States
(12) Patent Application Publication
(10) Pub. No.: US 2018/0304831 A1
(43) Pub. Date: Oct. 25, 2018

(54) ELECTRIC WIRE AND WIRE HARNESS

(71) Applicant: Yazaki Corporation, Tokyo (JP)

(72) Inventors: Shigeru Tanaka, Shizuoka (JP); Shigeo Mori, Shizuoka (JP); Masayuki Kataoka, Shizuoka (JP); Kouzou Koshou, Shizuoka (JP)

(21) Appl. No.: 15/951,007

(22) Filed: Apr. 11, 2018

(30) Foreign Application Priority Data
Apr. 24, 2017 (JP) 2017-085481

(51) Int. Cl. B60R 16/02; H02G 3/30; H01R 11/11

(52) U.S. Cl. CPC B60R 16/0215; H01R 11/11; H02G 3/30

(57) ABSTRACT

An electric wire is an electric wire to be routed under the floor of a vehicle such as an electric vehicle. The electric wire includes: a conductive first conductor that is formed in a single bar shape; a conductive second conductor that is formed by bundling a plurality of element wires; and a fusion junction that is formed by melting and joining an end of the first conductor and an end of the second conductor in a abutting state therebetween in an axial direction.

### CROSS-REFERENCE TO RELATED APPLICATION(S)

The present application claims priority to and incorporates by reference the entire contents of Japanese Patent Application No. 2017-085481 filed in Japan on Apr. 24, 2017.

### BACKGROUND OF THE INVENTION

### 1. Field of the Invention

The present invention relates to an electric wire and a wire harness.

### 2. Description of the Related Art

Conventionally, electric wires routed under the floor of a vehicle such as a hybrid electric vehicle (HEV) and an electric vehicle (EV) include an electrical line obtained by joining a single-core electric wire which is highly rigid and inexpensive and a stranded electric wire which is highly flexible in consideration of vehicle mounting conditions (for example, see Japanese Patent Application Laid-open No. 2016-32388).

In addition, a configuration in which a single-core electric wire and a stranded electric wire are connected substantially coaxially in a state where a collapsed portion formed in a conductor which exposes an end of the single-core electric wire and a junction block portion, formed by exposing an end of the stranded electric wire and welding each element wire, overlap each other is disclosed as a technique of joining the single-core electric wire and the stranded electric wire (for example, see Japanese Patent Application Laid-open No. 2016-58137).

However, there is room for improvement in Japanese Patent Application Laid-open No. 2016-32388 because the single-core electric wire and the stranded electric wire are connected via a member such as a terminal metal fitting and a joint terminal so that the number of parts increases. In addition, there is a room for improvement in Japanese Patent Application Laid-open No. 2016-58137 in terms of cost because an electrical resistance increases as a cross-sectional shape of the electric wire changes, and a forming process of the single-core electric wire and supersonic wave joining are required.

### SUMMARY OF THE INVENTION

An object of the invention is to provide an electric wire and a wire harness which enables easy joining of conductors having different configurations.

In order to achieve the above mentioned object, an electric wire according to one aspect of the present invention is an electric wire to be routed under a floor of a vehicle and includes a conductive first conductor that is formed in a single bar shape; a conductive second conductor that is formed by bundling a plurality of element wires; and a fusion junction that is formed by melting and joining an end of the first conductor and an end of the second conductor in a abutting state therebetween in an axial direction.

According to another aspect of the present invention, in the electric wire, it is possible to configure that the first conductor and the second conductor are formed by an identical material.

According to still another aspect of the present invention, in the electric wire, it is possible to configure that the first conductor and the second conductor are formed by different materials.

In order to achieve the above mentioned object, a wire harness according to still another aspect of the present invention is a wire harness to be routed under a floor of a vehicle and includes at least one of the electric wire.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic configuration diagram of a vehicle in which a wire harness according to an embodiment is laid;

FIG. 2 is a plan view illustrating a schematic configuration of an electric wire according to the embodiment;

FIG. 3 is an exploded perspective view illustrating a schematic configuration of the electric wire according to the embodiment;

FIG. 4 is a view for describing an example of a method of joining electric wires according to the embodiment;

FIG. 5 is a view for describing an example of the method for joining electric wires according to the embodiment;

FIG. 6 is a view for describing an example of the method for joining electric wires according to the embodiment; and

FIG. 7 is a side view illustrating a schematic configuration of an electric wire according to a modification of the embodiment.

### DETAILED DESCRIPTION OF THE PREFERRED EMBODIMENTS

Hereinafter, embodiments of an electric wire and a wire harness according to the invention will be described in detail with reference to the drawings. Incidentally, the invention is not limited by the following embodiments. In addition, constituent elements in the following embodiments include one that can be replaced by a so-called person skilled in the art or substantially the same one. In addition, various omissions, replacements, and modifications can be made to the constituent elements in the following embodiments below within a scope not departing from a gist of the invention.

### EMBODIMENT

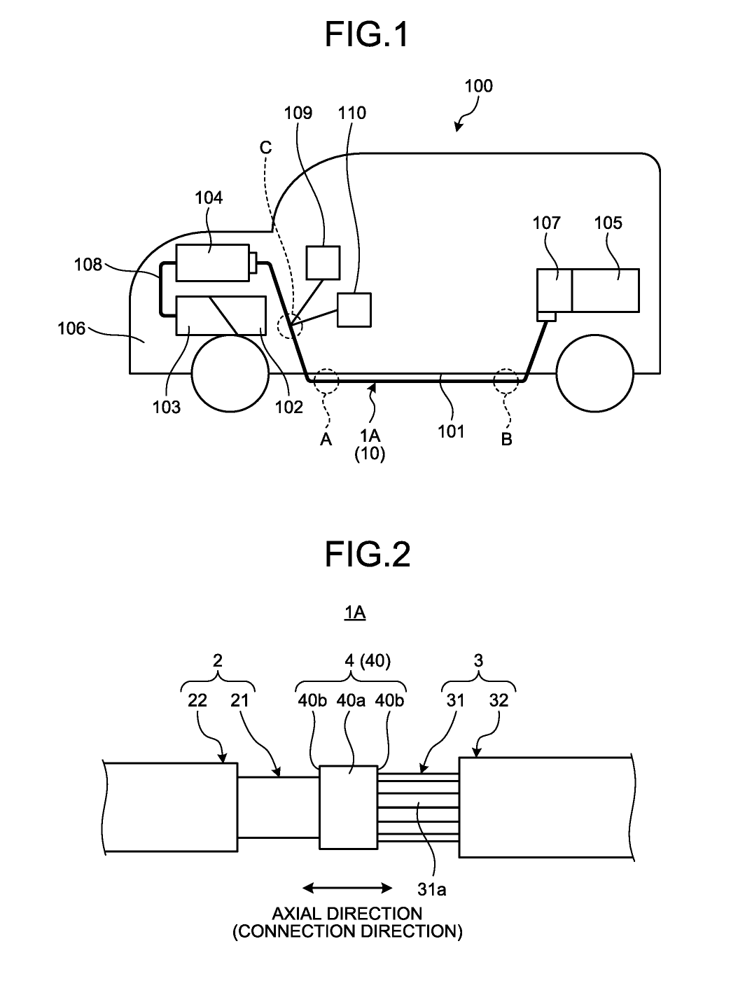

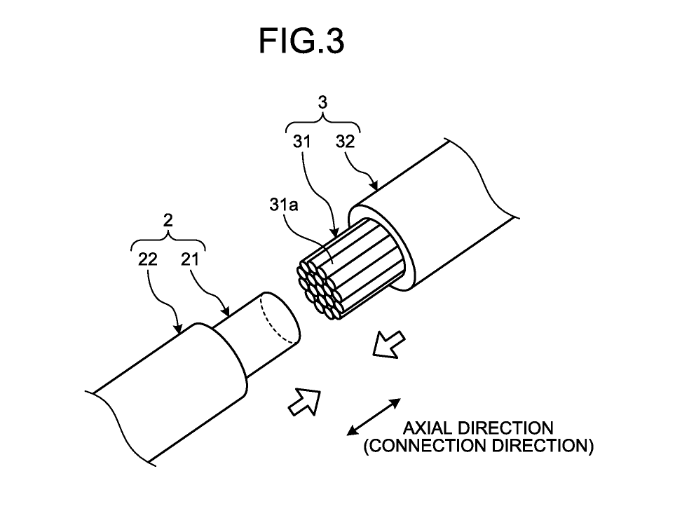

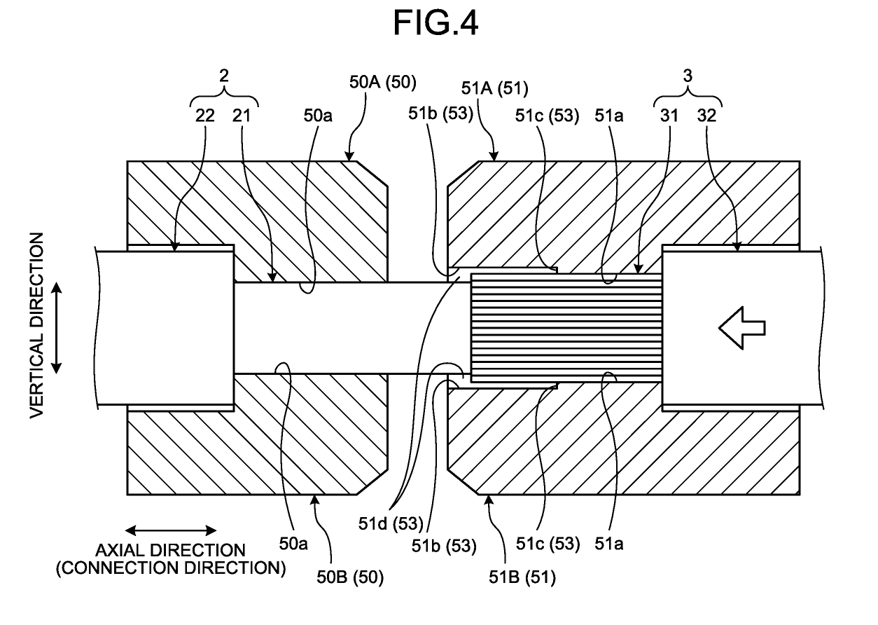

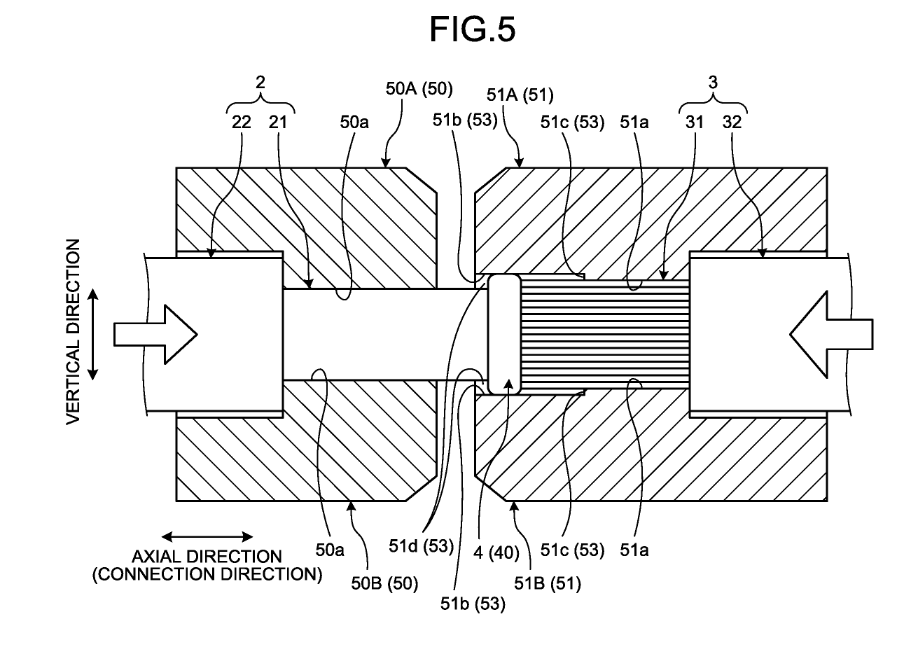

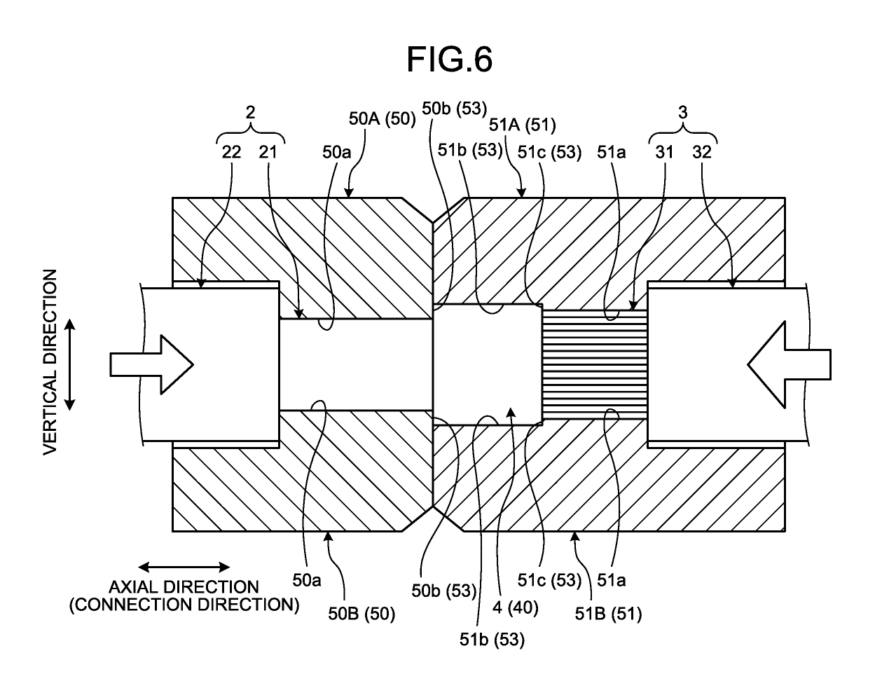

An electric wire and a wire harness according to an embodiment will be described with reference to FIGS. 1 to 6. FIG. 1 is a schematic configuration diagram of a vehicle in which the wire harness according to the embodiment is laid. FIG. 2 is a plan view illustrating a schematic configuration of the electric wire according to the embodiment. FIG. 3 is an exploded perspective view illustrating a schematic configuration of the electric wire according to the embodiment. FIGS. 4 to 6 are views for describing examples of a method of joining electric wires according to the embodiment. In addition, FIG. 4 illustrates a state at the time of joining two kinds of electric wires attached to jig electrodes. FIG. 5 illustrates a state in the middle of joining the two kinds of electric wires. FIG. 6 illustrates the state at the time of completing the joining of the two kinds of electric wires.

The wire harness according to this embodiment is laid, for example, under the floor of a vehicle such as an electric vehicle (EV), a hybrid electric vehicle (HEV), and a plug-in hybrid electric vehicle (PHEV), or the like. A wire harness 10 illustrated in FIG. 1 is formed by bundling a plurality of electric wires including an electric wire 1A according to this embodiment, and is mounted on a vehicle 100. The wire harness 10 connects devices in the vehicle 100 to each other and is used for power supply from a battery to the respective devices and communication between the devices. Incidentally, the wire harness 10 may be configured to include various other components, for example, a grommet, a fixture, and the like.

Here, the vehicle 100 will be described with reference to FIG. 1. The vehicle 100 is an HEV including both an engine 102 and a motor unit 103 as power sources for traveling. The vehicle 100 includes an underfloor portion 101, the engine 102, the motor unit 103, an inverter unit 104, a battery 105, an engine room 106, a junction box 107, a high-voltage wire harness 108, an air conditioner 109, a heater 110, and the wire harness 10.

A part of the wire harness 10 is routed in the underfloor portion 101. The motor unit 103 is constituted by a motor and a generator and connected to the inverter unit 104 via the high-voltage wire harness 108. The inverter unit 104 is constituted by an inverter and a converter and connected to the battery 105 via the wire harness 10. Power from the battery 105 is supplied to the inverter unit 104. The battery 105 is a Ni-MH based or Li-ion based secondary battery. The engine 102, the motor unit 103, and the inverter unit 104 are arranged in the engine room 106. One end of the wire harness 10 is connected to the junction box 107. That is, the wire harness 10 is connected to the battery 105 via the junction box 107 provided in the battery 105. The other end of the wire harness 10 is connected to the inverter unit 104.

As illustrated in FIG. 2, the electric wire 1A according to this embodiment includes a first electric wire 2, a second electric wire 3 in a different kind from the first electric wire 2, and a fusion junction 4.

The first electric wire 2 has relatively high rigidity, and its shape is easily held along a routing path. The first electric wire 2 includes a conductive first conductor 21 formed in a single bar shape and an insulative first insulating cover portion 22 covering an outer peripheral side of the first conductor 21 as illustrated in FIG. 3. The first conductor 21 is made of a conductive metal member. The first conductor 21 is formed in a bar shape and has a pillar-shaped conductor structure so as to have a cross-sectional shape that is substantially a perfect circle. The first conductor 21 is formed so as to extend to have substantially the same diameter with respect to an axial direction. The first conductor 21 is made of a conductive metal, for example, copper, a copper alloy, aluminum, an aluminum alloy, or the like. The first insulating cover portion 22 is an electric wire cover that covers the outer peripheral side of the first conductor 21. The first insulating cover portion 22 is provided in abutment with the outer peripheral surface of the first conductor 21. The first insulating cover portion 22 is formed, for example, by extrusion molding of an insulative resin material (which includes PP, PVC, cross-linked PE, and the like, and is appropriately selected in consideration of wear resistance, chemical resistance, heat resistance, and the like). The first insulating cover portion 22 is formed from one end to the other end of the first conductor 21 in the axial direction. The first insulating cover portion 22 of the first electric wire 2 is peeled off at the end of the first conductor 21, and the end of the first conductor 21 is exposed from the first insulating cover portion 22. An end of the second conductor 31 of the second electric wire 3 to be described later is physically and electrically joined to this end of the first conductor 21 of the first electric wire 2. As an example, the first electric wire 2 has a substantially circular cross-sectional shape in the axial direction of the first conductor 21 and a substantially annular cross-sectional shape in the axial direction of the first insulating cover portion 22, and has a substantially circular cross-sectional shape as a whole. Incidentally, the cross-sectional shape of the first conductor 21 is not limited to substantially the perfect circle, and may be, for example, a rectangle or the like, or the first conductor 21 may have a tubular conductor structure.

The second electric wire 3 has relatively high flexibility and favorable flexuosity. The second electric wire 3 includes a conductive second conductor 31 formed by bundling a plurality of element wires 31a and an insulative second insulating cover portion 32 covering an outer peripheral side of the second conductor 31 as illustrated in FIG. 3. The second conductor 31 is made of a conductive metal member. Each of the element wires 31a is formed to be linear and to extend to have substantially the same diameter with respect to the axial direction. The second conductor 31 has a different configuration from the first conductor 21. The element wire 31a constituting the second conductor 31 is formed using the same material as the first conductor 21, and is made of, for example, copper, a copper alloy, aluminum, an aluminum alloy, or the like. Here, the second conductor 31 is obtained by simply bundling the plurality of element wires 31a, but may be formed by stranding the plurality of element wires 31a. The second insulating cover portion 32 is an electric wire cover that covers the outer peripheral side of the second conductor 31. The second insulating cover portion 32 is provided in abutment with the outer peripheral surface of the second conductor 31. The second insulating cover portion 32 is formed, for example, by extrusion molding of an insulative resin material (which includes PP, PVC, cross-linked PE, and the like, and is appropriately selected in consideration of wear resistance, chemical resistance, heat resistance, and the like). The second insulating cover portion 32 is formed from one end to the other end of the second conductor 31 in the axial direction. The second insulating cover portion 32 of the second electric wire 3 is peeled off at the end of the second conductor 31, and the end of the second conductor 31 is exposed from the second insulating cover portion 32. The above-described end of the first conductor 21 of the first electric wire 2 is physically and electrically joined to this end of the second conductor 31 of the second electric wire 3. As an example, the second electric wire 3 has a substantially circular cross-sectional shape in the axial direction of the second conductor 31 and a substantially annular cross-sectional shape in the axial direction of the second insulating cover portion 32, and has a substantially circular cross-sectional shape as a whole.

The fusion junction 4 is formed by physically and electrically joining the first electric wire 2 and the second electric wire 3. The fusion junction 4 is in a state, for example, where the end of the first conductor 21 and the end of the second conductor 31 match each other in the axial direction and fused and joined to each other by electric heating and joining. Here, the electric heating and joining is a method of performing joining by energizing two metal conductors to be welded to generate resistance heat (Joule heat), fusing the metal conductors to each other and then pressing the resultant in the axial direction. A connection direction of the first conductor 21 and the second conductor 31 in the fusion junction 4 is a direction along the axial direction of the first conductor 21 and the second conductor 31. The wire harness 10 is arranged such that the fusion junction 4 is located at positions A and B illustrated in FIG. 1, and a portion to be routed in the underfloor portion 101 becomes the first electric wire 2, and the other portions become the second electric wires 3. The fusion junction 4 has a fused portion 40 formed at the time of joining.

The fused portion 40 is a portion that is obtained by molding a fused material bulging outward from an outer peripheral surface of the fusion junction 4 with a molding surface of a jig electrode (or a jig) used at the time of electric heating and joining. The fused portion 40 has an outer surface 40a and a pair of annular surfaces 40b. The outer surface 40a is formed in an orthogonal direction (hereinafter also referred to as a “perpendicular direction”) orthogonal to the axial direction from the outer peripheral surface of the fusion junction 4 so as to turn full circle around the axial direction in parallel to the axial direction. The pair of annular surfaces 40b are formed in the orthogonal direction orthogonal to the axial direction from both axial ends of the outer surface 40a, respectively, toward the outer peripheral surfaces of the first conductor 21 and the second conductor 31.

Next, a method of joining the above-described electric wire 1A will be described with reference to FIGS. 4 to 6. An electric heating and joining device (not illustrated) including a pair of jig electrodes is used in the method of joining the electric wire 1A according to the first embodiment.

First, the first electric wire 2 in which the end of the first conductor 21 is exposed from the first insulating cover portion 22 and the second electric wire 3 in which the end of the second conductor 31 is exposed from the second insulating cover portion 32 are set in the electric heating and joining device in a holding and abutment process. Specifically, the first conductor 21 and the second conductor 31 are arranged to face each other in the axial direction, the end of the first conductor 21 is held by a holding surface 50a in a first jig electrode 50 (50A and 50B) from the outer peripheral side, and the end of the second conductor 31 is held by a holding surface 51a in a second jig electrode 51 (51A and 51B) from the outer peripheral side.

Each of the first jig electrode 50 and the second jig electrode 51 is not only an electrode for welding but also a jig to hold the first conductor 21 and the second conductor 31 to be welded. The first jig electrode 50 and the second jig electrode 51 hold the first conductor 21 and the second conductor 31 such that the end face of the first conductor 21 and the end face of the second conductor 31 face each other in the axial direction. The first jig electrode 50 is configured in the state of being divided into an upper jig electrode 50A and a lower jig electrode 50B. The upper jig electrode 50A and the lower jig electrode 50B hold the end of the first conductor 21 so as to be sandwiched from the orthogonal direction (for example, the vertical direction illustrated in FIG. 4). The second jig electrode 51 is configured in the state of being divided into an upper jig electrode 51A and a lower jig electrode 51B, which is similar to the first jig electrode 50. The upper jig electrode 51A and the lower jig electrode 51B hold the end of the second conductor 31 from the orthogonal direction (for example, the vertical direction illustrated in FIG. 4).

The first jig electrode 50 has the holding surface 50a and an abutment surface 50b. The holding surface 50a is a first holding surface and holds the first conductor 21 from the outer peripheral side. The holding surface 50a is a cylindrical inner peripheral surface and is divided in the orthogonal direction. That is, the holding surface 50a holds the end of the first conductor 21 so as to be sandwiched from the orthogonal direction. The abutment surface 50b is a portion which is formed on an axial end face of the first jig electrode 50 and abuts on an axial end face of the second jig electrode 51.

The second jig electrode 51 has the holding surface 51a, a first molding surface 51b, and a second molding surface 51c. The holding surface 51a is a second holding surface and holds the second conductor 31 from the outer peripheral side. The holding surface 51a is a cylindrical inner peripheral surface and is divided in the orthogonal direction. That is, the holding surface 51a holds the end of the second conductor 31 so as to be sandwiched from the orthogonal direction. The first molding surface 51b is a cylindrical inner peripheral surface formed on the fusion junction 4 side in the axial direction from the holding surface 51a. The first molding surface 51b forms the outer surface 40a of the fused portion 40. The first molding surface 51b forms a molding surface so as to turn full circle around the axial direction in parallel to the axial direction as the first jig electrode 50 and the second jig electrode 51 abut pm each other in the axial direction. The second molding surface 51c is a molding surface that forms the annular surface 40b of the fused portion 40.

The first jig electrode 50 and the second jig electrode 51 according to this embodiment have a bulging molding portion 53 formed so as to surround the fused material generated from the fusion junction 4 during a joining and molding process illustrated in FIG. 5. Specifically, the bulging molding portion 53 is constituted by the abutment surface 50b, the first molding surface 51b, the second molding surface 51c, and a bulging space portion 53a. The bulging space portion 53a is a space filled with the fused material bulging outward from the outer peripheral surface of the fusion junction 4. The bulging space portion 53d is a space closed by the first molding surface 51b, the second molding surface 51c, and the abutment surface 50b of the first jig electrode 50 in the joining and molding process.

Next, the first jig electrode 50 and the second jig electrode 51 are relatively moved in the state of facing each other in the axial direction such that the end face of the first conductor 21 and the end face of the second conductor 31 abut on each other in the joining and molding process illustrated in FIGS. 5 and 6. Then, the end face of the first conductor 21 and the end face of the second conductor 31 are joined to each other in a abutting state in the axial direction while being heated by energizing the first jig electrode 50 and the second jig electrode 51. Specifically, the end face of the first conductor 21 is heated by energizing the first jig electrode 50, and the end face of the second conductor 31 is heated by energizing the second jig electrode 51. The end face of the first conductor 21 and the end face of the second conductor 31 are heated to be lower than a melting point of each conductor, that is, before reaching the melting point, and then, the end of the first conductor 21 and the end of the second conductor 31 are pressed against each other in the axial direction until the axial end of the first jig electrode 50 and the axial end of the second jig electrode 51 about each other. At this time, the fused material generated at the time of fusing the first conductor 21 and the second conductor 31 bulges into the bulging space portion 53a, and the abutment surface 50b, the first molding surface 51b, and the second molding surface 51c form the fused portion 40.

As described above, the electric wire 1A according to this embodiment includes: the conductive first conductor 21 that is formed in the single bar shape; the conductive second conductor 31 that is formed by bundling the plurality of element wires 31a; and the fusion junction 4 that is formed by melting and joining an end of the first conductor 21 and an end of the second conductor 31 in a abutting state therebetween in an axial direction.

According to the electric wire 1A and the wire harness 10 according to this embodiment, it is possible to easily join conductors having different configurations. For example, it is possible to reduce pressure in the axial direction required for joining of the two conductors by electrically heating and fusing the end of the first conductor 21 and the end of the second conductor 31 in the abutting state in the axial direction, and it is possible to avoid buckling at the time of joining a stranded electric wire and to perform stable joining. In addition, since the end of the first conductor 21 and the end of the second conductor 31 are fused and joined in the abutting state in the axial direction, it is possible to perform joining while maintaining a cross-sectional shape of the electric wire, and it is possible to suppress an increase in electrical resistance and to suppress heat generation during energization. In addition, it is unnecessary to perform pretreatment such as crushing of the end of the conductor in order for joining, and thus, it is possible to reduce processing cost. In addition, a stranded electric wire has been conventionally used for each electric wire forming the wire harness 10, but it is possible to reduce cost of parts by using a single-core electric wire which is less expensive than the stranded electric wire and which does not require a protective member such as a protector at the time of routing in the underfloor portion 101 of the vehicle 100.

In addition, the first conductor 21 and the second conductor 31 are formed by the same material in the electric wire 1A. As a result, the first conductor 21 and the second conductor 31 have the same melting point so that it is possible to set the same heating condition for the respective conductors using the first jig electrode 50 and the second jig electrode 51, and to stably join the two conductors.

Modification

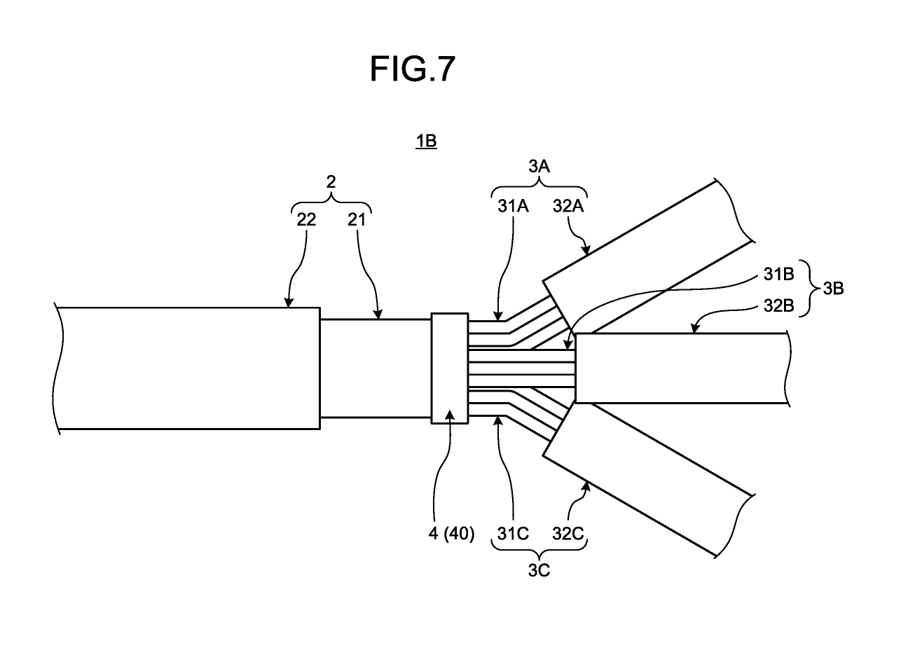

Next, an electric wire according to a modification of the embodiment will be described with reference to FIG. 7. FIG. 7 is a view illustrating a schematic configuration of the electric wire according to the modification of the embodiment.

An electric wire 1B according to this modification of the embodiment is different from the electric wire 1A in the above-described embodiment in terms that the single first electric wire 2 is connected to a plurality of second electric wires 3A, 3B, and 3C are connected. Incidentally, common parts to the above-described embodiment will be denoted by the same reference signs, and will not be described in this modification of the embodiment.

The electric wire 1B includes the single first electric wire 2, the three second electric wires 3A, 3B, and 3C, and the fusion junction 4. Each of the second electric wires 3A, 3B, and 3C has the same configuration as the second electric wire 3. The fusion junction 4 is in a state where an end of the first electric wire 2 and each end of the three second electric wires 3A, 3B, and 3C are fused and joined in a abutting state in a substantially axial direction.

According to the electric wire 1B and the wire harness 10 according to this modification of the embodiment, it is possible to easily perform joining even if one of conductors, which have different configurations, is provided in plural, and to efficiently manufacture an electric wire having a branch. For example, it is easy to make the electric wire to be branched to the air conditioner 109 and the heater 110 by arranging the fusion junction 4 of the electric wire 1B in a part C illustrated in FIG. 1.

Incidentally, the first conductor 21 and the second conductor 31 are formed by the same material in the above description, but may be formed by different materials without being limited thereto. That is, the first conductor 21 and the second conductor 31 may be configured using the same metal member having conductivity or may be configured using different metal members having conductivity. For example, there is a case where the first conductor 21 is made of aluminum or an aluminum alloy and the second conductor 31 is made of copper or a copper alloy.

In addition, the first conductor 21 and the second conductor 31 are sandwiched by the first jig electrode 50 and the second jig electrode 51, respectively, from the vertical direction in the above description, but may be sandwiched from a width direction orthogonal to the axial direction and the vertical direction without being limited thereto.

In addition, the number of the second conductors 31 joined to the single first conductor 21 is three in the above description as illustrated in FIG. 7, but is not limited thereto. In addition, the second electric wires 3A to 3C may have the same specifications such as a configuration and an outer diameter of the second conductor 31, and a thickness of the second insulating cover portion 32, or may have specifications different from each other.

According to the electric wire and the wire harness of the embodiment, it is possible to easily join the conductors having different configurations.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electric wire to be routed under a floor of a vehicle, the electric wire comprising:
a conductive first conductor that is formed in a single bar shape;
a conductive second conductor that is formed by bundling a plurality of element wires; and
a fusion junction that is formed by melting and joining an end of the first conductor and an end of the second conductor in a abutting state therebetween in an axial direction.

2. The electric wire according to claim 1, wherein
the first conductor and the second conductor are formed by an identical material.

3. The electric wire according to claim 1, wherein
the first conductor and the second conductor are formed by different materials.

4. A wire harness to be routed under a floor of a vehicle, the wire harness comprising:
at least one of the electric wire according to claim 1.
